(19) United States
(12) Patent Application Publication
(10) Pub. No.: US 2021/0140307 A1
(43) Pub. Date: May 13, 2021

(54) Removing the Effect of Near-Surface Inhomogeneities in Surface-to-Borehole Measurements

(71) Applicant: Saudi Arabian Oil Company, Dhahran (SA)

(72) Inventors: Gary W. McNeice, Dhahran (SA); Daniele Colombo, Dhahran (SA)

(73) Assignee: Saudi Arabian Oil Company, Dhahran (SA)

(21) Appl. No.: 16/681,425

(22) Filed: Nov. 12, 2019

(51) Int. Cl. E21B 47/12; G01V 1/38

(52) U.S. Cl. CPC E21B 47/122; G01V 1/3817; G01V 1/3808

(57) ABSTRACT

Systems and methods for removing galvanic distortion caused by near-surface inhomogeneities from surface-to-borehole (STB) measurements are disclosed. Corrected STB measurements may provide for a representation of the resistivity of an oil-bearing reservoir and may be used to determine movement of a waterfront within the reservoir caused by waterflooding of the reservoir.

### TECHNICAL FIELD

The present disclosure is directed to systems and methods for subsurface surveying.

### BACKGROUND

Waterflooding is a common primary recovery method used in oil production. In waterflooding, saline water is injected at a periphery of the reservoir to maintain pressure and sweep the reservoir formation. The substitution of oil with saline water in typical reservoir formations can lead to an order of magnitude change in resistivity. Surface-to-borehole (STB) electromagnetic measurements are sensitive to this change in resistivity and can be used to monitor oil recovery in both standalone and time-lapse surveys. STB uses an array of surface electric field sources and vertical electric and magnetic field measurements recorded downhole at the reservoir depths. Analysis of the fields measured in the borehole provides an estimate of the resistivity of the surrounding reservoir.

### SUMMARY

The present disclosure describes techniques that can be used for removing the effects of near-surface galvanic distortion caused by near-surface inhomogeneities in the shallow resistivity structure from surface-to-borehole survey measurements.

The substitution of oil with saline water in typical reservoir formations can lead to an order of magnitude change in resistivity. Thus, changes in resistivity within a reservoir are representative of movement of the waterfront within the reservoir and, consequently, depletion of the oil from the reservoir. Numerical simulations have shown that surface-to-borehole (STB) electromagnetic measurements are sensitive to this change in resistivity in the reservoir caused by waterflooding and can be used to monitor oil recovery in both standalone and time-lapse surveys.

STB methods can use an array of surface electric field sources along with vertical electric field measurements or both vertical electric and magnetic field measurements recorded downhole at reservoir depths. Analysis of the fields measured in the borehole provides an estimate of the resistivity of the surrounding reservoir.

However, since the measured fields propagate from the surface, knowledge of the overburden structure and resistivity and wellbore casing is needed in order to provide meaningful information of the reservoir condition. The resistivity of the overburden structure may be determined through well logging or surface geophysical investigations or both. This overburden structure and resistivity information is typically derived from interpretation of seismic horizons, surface non-seismic methods (for example, magnetotellurics), and the interpolation of well log information.

An additional problem that affects many land electrometric methods, including STB, is near-surface galvanic distortion of both received and transmitted surface electric field measurements. This distortion is created by near-surface variations in resistivity structure. Near-surface galvanic distortion can be mitigated through dense sampling of the near-surface with shallow electromagnetic (EM) investigations. However, dense sampling of the near-surface increases operational costs.

Similar to other geophysical techniques that depend on electric field measurements made at the surface of the earth, STB measurements are affected by near-surface inhomogeneities in the shallow resistivity structure, which creates distortion. This distortion is termed “static shift.” The term “static” refers to frequency-independent distortions of the electric field that occur at lower frequencies where induction currents in the near-surface resistivity variation have decayed away. Typically, STB survey measurements are performed at frequencies between 0.1 and 10 Hertz (Hz) where this assumption is often valid. In this situation, the measured or transmitted electric field is the electric field of the larger structure multiplied by a real 2×2 frequency-independent distortion tensor.

A first aspect of the present disclosure is directed to a surface-to-borehole (STB) arrangement for collecting electric field and magnetic field data representative of a resistivity of a reservoir and overburden formations, the resistivity representing a depletion level of oil from the reservoir. The STB arrangement may include a plurality of dipole transmitters arranged in a plurality of radials extending outwards from a borehole, each radial being aligned with another radial on an opposing side of the borehole; an STB receiver disposed in the wellbore at a level of the reservoir; and a plurality of reference stations. The STB receiver may be operable to measure a vertical electric field and a vertical magnetic field generated by one or more of the dipole transmitters, as affected by the reservoir and overburden formations. One of the plurality of reference stations may be disposed along each radial outwards from the plurality of dipole transmitters. The reference stations may include a recording system operable to measure a vertical component of a present magnetic field and horizontal electric field components generated by one or more of the dipole transmitters.

A second aspect of the present disclosure is directed to a method of removing galvanic distortion associated with near-surface inhomogeneities from surface-to-borehole (STB) survey measurements to provide resistivity information of an oil-bearing reservoir. The method may include generating a horizontal electric field and a vertical magnetic field at a surface of the earth with a dipole transmitter; measuring the vertical electric field and the vertical magnetic field at a depth of the reservoir; measuring a vertical magnetic field at a reference station; determining a direct current (DC) magnetic field value for the dipole transmitter through low frequency transmission (for example, between 0.1 and 10 Hz); equating the vertical magnetic field recorded at the reference station to the determined DC value according to the equation

$${H}_{z} = \frac{I dl cos Θ}{4 π {R}^{2}} ;$$

solving for I dl from the equation to determine a static shift correction factor; and applying the static shift correction factor to the vertical magnetic field measurements measured at the depth of the reservoir, the vertical electric field measurements measured at the depth of the reservoir, to remove the galvanic distortion associated with near-surface inhomogeneities and provide resistivity representation of the reservoir.

Another aspect of the present disclosure is directed to a method of removing galvanic distortion associated with near-surface inhomogeneities from surface-to-borehole (STB) survey measurements to provide resistivity information of an oil-bearing reservoir. The method may include generating a first electric field and a first magnetic field at a first location on a surface of the earth, the first electric field comprising a radial component, E_{radial1}, and an azimuthal component, E_{azimuthal1}, and the first magnetic field comprising a vertical component, H_{vertical1}; generating a second electric field and a second magnetic field at a second location on a surface of the earth, the second electric field comprising a radial component, E_{radial2}, and an azimuthal component, E_{azimuthal2}, and the second magnetic field comprising a vertical component, H_{vertical2}; measuring E_{vertical1}, E_{vertical2}, H_{vertical1}, and H_{vertical2} at a depth of the reservoir; measuring E_{radial1}, E_{radial2}, E_{azimuthail1}, E_{azimuthal2}, H_{vertical1}, and H_{vertical2} at first and second measuring locations at a surface of the earth; determining distortion parameters through scaling factors S_{Tx1}, S_{Tx2}, S_{R1}, and S_{R2} according to the following set of equations:

E₁=S_{Tx1}S_{R1}E_{1undistorted};

E₂=S_{Tx1}S_{R2}E_{2undistorted};

E₃=S_{Tx2}S_{R1}E_{3undistorted};

E₄=S_{Tx2}S_{R2}E_{4undistorted};

where E₁ corresponds to E_{radial1} measured at the first measuring location, where E₂ corresponds to E_{radial1} measured at the second measuring location, where E₃ corresponds to the E_{radial2} measured at the first measuring location, where E₄ corresponds to E_{radial2} measured at the second measuring location, where E_{1undistorted} corresponds to a radial electric field at the first location without near surface inhomogeneities, where E_{2undistorted} corresponds to a radial electric field at the second location without near surface inhomogeneities, where E_{3undistorted} corresponds to a radial electric field at the first location without near surface inhomogeneities, and where E_{4undistorted} corresponds to a radial electric field at the second location without near surface inhomogeneities, E_{1undistorted}, E_{2ndistorted}, E_{3undistorted}, and E_{4ndistorted} being predicted values obtained from a starting resistivity model, determining the distortion tensor by applying an inversion to the set of equations; and applying the distortion tensor during an inversion of the E_{radial1} and E_{radial2} measured at the first and second measurement locations to remove the galvanic distortion associated with near-surface inhomogeneities and provide a resistivity representation of the reservoir. This distortion removal procedure may be extended to include a plurality of dipole transmitters to simultaneously remove galvanic distortion from an entire surface to borehole survey.

The various aspects may include one or more of the following features. The adjacent radials may be angularly offset by 45°. Each radial may include nine dipole transmitters. The dipole transmitters may be equally spaced along the radials. Each of the reference stations may be disposed 5 kilometers (km) from the borehole. Each reference station may be adapted to measure the vertical magnetic field generated by at least one of the dipole transmitters disposed on a radial aligned with and on an opposite side of the borehole from the radial on which the reference station is disposed. In some implementations, a distance between one of the plurality of reference stations and one of the plurality of the dipole transmitters whose electric field to be measured by the reference station may be within a range of 6 km to 10 km. However, the scope of the disclosure is not so limited. In other implementations, one or more of the reference stations may be located at a distance of less than 6 km from one or more of the dipole transmitters or greater than 10 km from one or more of the dipole transmitters.

The various aspects may also include one or more of the following features. Generating a vertical magnetic field at a surface of the earth with a dipole transmitter may include generating a magnetic field with each of a plurality of dipole transmitters. The plurality of dipole transmitters may be arranged in a plurality of radials extending outwards from a borehole, each radial being aligned with another radial on an opposing side of the borehole. Measuring a vertical magnetic field may include measuring the low frequency magnetic field generated by the STB transmitting dipoles. Determining a DC value for the dipole transmitter may include determining a DC value for each dipole transmitter of the plurality of dipole transmitters. Measuring the vertical magnetic field at a depth of the reservoir may include measuring the vertical magnetic field with an STB receiver disposed in the borehole at a depth of the reservoir.

The various aspects may also include one or more of the following features. Generating a first electric field and a first magnetic field at a first location on a surface of the earth may include generating the first electric field and the first magnetic field with a dipole transmitter. Generating a second electric field and a second magnetic field at a second location on a surface of the earth may include generating the second electric field and the second magnetic field with a second dipole transmitter. The first location may be disposed on a first side of a borehole extending from the surface to the reservoir, and the second location is located opposite the first side. The first dipole transmitter may be disposed in a first radial of an array of dipole transmitters. The second dipole transmitter may be disposed in a second radial of the array of dipole transmitters, and the first radial may be aligned with the second radial. The first dipole transmitter and the second dipole transmitter may form an array of dipole transmitters. The array of dipole transmitters may be arranged in a plurality of radials extending outwardly from the borehole. Radials on opposing sides of the borehole may be aligned. The measurements obtained at the first measuring location and the second measuring location may be obtained by a first reference station located at the first measuring location and a second reference station located at the second measuring location. The first reference station and the second reference station may form part of a plurality of measuring stations. Each of the plurality of measuring stations may be aligned with one of the radials of the plurality of radials and may be disposed radially outwards of the dipole transmitters disposed in the radial in which the measuring station is located.

The details of one or more embodiments of the disclosure are set forth in the accompanying drawings and the description that follows. Other features, objects, and advantages of the disclosure will be apparent from the description and drawings, and from the claims.

### DESCRIPTION OF DRAWINGS

FIG. 1 is an example realistic earth 3D resistivity model that includes a formation containing an oil-bearing reservoir.

FIG. 2 is an example STB survey design for use in collecting measurements used to remove galvanic distortion associated with near-surface inhomogeneities from STB survey measurements so as to gain resistivity information of an oil-bearing reservoir.

FIG. 3 is an example reference station that may be used in the STB survey design of FIG. 2.

FIG. 4 illustrates an example plot of amplitude response of a vertical magnetic field for a 6 km transmitter-receiver separation and halfspace resistivities varying between 10 and 1000 ohm-meters (ohm-m) measured by a reference station.

FIG. 5 graphically illustrates correction of distorted STB survey measurements using a correction factor obtained from reference vertical magnetic field measurements.

FIG. 6 is a plan view of the example realistic earth 3D resistivity model of FIG. 1 used to illustrate removal of the near-surface galvanic distortion caused by near-surface inhomogeneities.

FIG. 7 is a section view of the example realistic earth 3D resistivity model of FIG. 1 taken along two aligned radials of STB transmitters.

FIG. 8 illustrates an example amplitude graph of vertical electric field measurements obtained using the realistic earth 3D resistivity model of FIG. 1.

FIG. 9 is the phase of vertical electric field data measured by a receiver within the example realistic earth 3D model of FIG. 1.

FIG. 10 is another cross-section of the realistic earth 3D resistivity model shown in FIG. 1 taken along two aligned radials of STB transmitters and shows acquisition of electric field measurements produced by two STB transmitters by a downhole receiver and surface receivers.

FIG. 11 illustrates the amplitude of the simulated STB survey electric field measurements presented in FIG. 8 but corrected with a distortion tensor obtained through inversion of reference electric field data.

FIG. 12 is a flowchart illustrating an example method for obtaining resistivity measurements of a reservoir using STB survey measurements corrected with a correction factor derived from reference vertical magnetic field measurements.

FIG. 13 is a flowchart illustrating an example method for obtaining resistivity measurements of a reservoir using STB survey measurements corrected with a distortion tensor found through inversion of reference measurements.

FIG. 14 is a block diagram illustrating an example computer system used to provide computational functionalities associated with described algorithms, methods, functions, processes, flows, and procedures as described in the present disclosure, according to some implementations of the present disclosure.

Like reference symbols in the various drawings indicate like elements.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. In particular, it is fully contemplated that the features, components, steps, or a combination of these described with respect to one implementation may be combined with the features, components, steps, or a combination of these described with respect to other implementations of the present disclosure.

The present disclosure is directed to removal of near-surface galvanic distortions in surface-to-borehole (STB) survey measurements caused by near-surface inhomogeneities in the shallow resistivity structure. The shallow resistivity structure may be located between the surface and 50 meters (m) in depth. Inhomogeneities are variations in the geology of a formation, which give rise to changes in resistivity of the structure of the formation. Similar to other geophysical techniques that depend on electric field measurements made at the surface of the earth, STB measurements are affected by near-surface inhomogeneities in the shallow resistivity structure. This distortion is manifested as a frequency-independent shift in the amplitude of the measured vertical electric field and is termed “static shift.” The term “static” refers to the frequency-independent distortion of the electric field that occur at frequencies where induction currents in the near-surface resistivity variation have decayed away. Typically, STB survey measurements are performed at frequencies between 0.1 and 10 Hertz (Hz) where this assumption is often valid. In this situation, the measured or transmitted electric field can be viewed as the electric field of the larger structure or undistorted overburden (that is, the overburden without near surface variations) that is unaffected by the near-surface galvanic distortions multiplied by a real 2×2 frequency-independent distortion tensor. The 2×2 frequency-independent distortion tensor is used to describe static shift in magnetotelluric measurements. This relationship is discussed in more detail later, and a purpose of this disclosure is to obtain the electric field of the larger structure that is free of the near-surface galvanic distortions. Thus, the systems and methods described can isolate and remove the near-surface galvanic distortion from the STB survey measurements. Removal of the near-surface galvanic distortion may be performed in a process that is independent of the borehole STB measurements, which may themselves be affected by changes occurring in the borehole. Such changes may include, for example, those related to the injection of conductive kill fluids into the borehole.

STB measurements are recorded using a three-dimensional (3D) surface array of grounded dipole transmitters centered on the borehole under investigation, as shown in FIG. 1. FIG. 1 shows a formation 100 containing an oil-bearing reservoir 112, a borehole 114 extending from a surface 116 to the reservoir 112, and a receiver 120 located in the borehole 114. The receiver 120 may be included as part of, or otherwise included on, a wireline and conveyed within the borehole 114. In still other implementations, the receiver 120 may be permanently located at a location in the borehole 114. In some instances, the receiver 120 can measure electric fields, magnetic fields, or both electric and magnetic fields, at varying depths within the borehole 114, including the reservoir 112. A plurality of formations 122 overlay the reservoir 112. An array of grounded dipole transmitters 118 are shown at the surface 116. Numerical modeling studies of 3D STB measurements, using resistivity distributions derived from a black oil reservoir simulator, suggest that the vertical electric field has sensitivity to time-lapse variations in a position of the waterfront within the reservoir 112. Simulation of a two year time-lapse survey suggested that a detectable signal would be obtained with an estimated noise floor of 1×10⁻¹² volts per meter (V/m). All other components of the EM radiation were less than the expected instrumentation noise floor.

Removal of the galvanic distortion caused by near-surface inhomogeneities in the shallow resistivity structure is important in order to evaluate an oil-bearing reservoir. In obtaining the STB survey measurements, careful preparation of the transmitter dipoles may be undertaken to reduce electric field distortion. The electric field distortion is often created by shallow resistive or conductive overburden. Particularly, this distortion is the result of the inhomogeneities in the shallow resistivity structure. These previous approaches involve drilling through the shallow overburden to penetrate into the subsurface formation in order to reduce the electric field distortion. For example, in some implementations, the subsurface formation may be penetrated by at least 5 meters. In other implementations, the subsurface formation may be penetrated by less than 5 meters. However, this approach requires boreholes ranging from approximately 6 to 15 meters in depth and comes at a considerable cost. The methods described in the present disclosure avoid this time consuming and expensive step.

Analysis of the STB measurements is carried out through modeling the propagation of the electric field from the surface source. As illustrated, the array of grounded dipole transmitters 118 transmit EM signals into the formation 100. The receiver 120 located in the borehole 114 records the attenuated signals. In this particular instance, the resistivity of the reservoir 112 is used to determine movement of the waterfront, so the receiver 120 is positioned within the borehole 114 at a depth of the reservoir 112. This analysis is based on the amplitude and phase of the EM signals recorded by the receiver 120. These EM signals are measured, and phenomena effecting propagation of the EM signals are accounted for in the model.

In order to derive useful estimates of the reservoir resistivity surrounding the borehole 114, information describing the structure and resistivity of the overlying formations 122, as shown in FIG. 1, is collected. The resistivity of the layers is shown graphically in key 126. The resistivity is measured in ohm-meters (ohm-m). In addition, the effect of any steel wellbore casing is also collected and included in the analysis. In some implementations, the effect of the wellbore casing (referred to as the “casing response”) may be modeled and subtracted or otherwise removed from STB survey measurements. In other implementations, a model of the wellbore casing may be added to an inversion model of the overburden and reservoir in order to account for the casing response. In some implementations, the larger scale structure of the overlying formations 122 may be determined, for example, using 3D seismic interpretation of horizons, and resistivity within the formations 122 may be derived through the interpolation of well logs or regional electromagnetic investigations. However, small-scale near surface resistivity variations in the shallow resistivity structure, such as those related to surface weathering and variable sand cover, may be more difficult to account for. Amplitude variations related to small-scale near-surface variations are incorporated in order to recover estimates of the reservoir resistivity and, as a result, movement of the waterfront within the reservoir over time.

The inhomogeneities that generate the near-surface galvanic distortion are generally located within a formation 124 of the overlying formations 122 extending from the surface to approximately 10 meters below the surface, which is referred to as a shallow resistivity structure. In some instances, the formation containing the inhomogeneities may extend from one meter to 100 meters from the surface.

FIG. 2 is an example STB survey design 200 in accordance with some implementations of the present disclosure. The STB survey may be performed at a single frequency or a range of frequencies, such as those within a range of 0.1 Hz to 10 Hz. The STB survey design 200 includes an array of grounded electric field source dipoles, interchangeably referred to as transmitters 202; a receiver 204 disposed within a borehole 206 (that may be similar to the receiver 120 described earlier); and a plurality of reference stations 208. The transmitters 202 are typically in the form of grounded dipoles that are arranged in radial and azimuthal orientations. The transmitters 202 are arranged on radials 210 at the surface and extend outwardly from a central location where the borehole 206 is located. In the illustrated example, the radials 210 are angularly offset from adjacent radials 210 by 45°. In other implementations, adjacent radials 210 may be offset by an angular amount that is less than or greater than 45°. Thus, in other implementations, more or fewer radials may be used. In the illustrated example, nine transmitters 202 are disposed along each radial 210. The transmitters 202 on each radial are positioned at a regular intervals such that adjacent transmitters 202 are equally spaced from one another. In some implementations, an equal spacing 212 is 500 meters. In other implementations, spacing 212 between adjacent transmitters 202 may be within a range of 100 meters to 1000 meters. However, the scope of the disclosure is not so limited. In other implementations, the spacing 212 between adjacent transmitters 202 may be irregular and the transmitters 202 along each radial 210 may be spaced at varying intervals. Moreover, the transmitter spacing 212 along a radial 210 may be selected to measure spatial changes in the measured electric and magnetic field produced by an STB survey. For example, the pattern of the layout of the transmitters 202 and a length of the grounded dipoles may be a function of the depth from the surface of the reservoir as well as a desired resolution. In still other instances, the layout of the transmitters 202 may also be affected by surface infrastructure, such as roads, power lines, and wells.

The reference stations 208 for each profile are installed in an azimuthal and radial orientation with respect to the well. For example, as shown in FIG. 2, the reference stations 208 are also disposed on the radials 210. The reference stations 208 are located radially outward from the transmitters 202 along each radial 210. Thus, the reference stations 208 are positioned such that the plurality of transmitters 202 on each radial 210 are disposed between the borehole 206 and the corresponding reference station 208. As shown in FIG. 2, radials 210 on opposite sides of the borehole 206 are aligned. In other implementations, radials 210 need not be aligned.

Each reference station 208 is located at a distance along a radial 210 where the vertical magnetic field from low frequency transmission approximates a direct current (DC) field for the transmitters 202 located on the same side of the borehole 206. The location of a reference station 208 is dependent on the average resistivity of the overburden. Particularly, the reference station 208 is located in the near-field of a transmitter 202, where the separation of a transmitter 202 and a reference station 208 is less than the skin depth. The skin depth is determined according to the following equation: Skin Depth=503× \sqrt{(Resistance/Frequency)} (Equation 1), where the Resistance is an average overburden resistivity (that may be obtained from well logs) and the Frequency is the transmission frequency. However, for typical oil bearing formations, the reference stations 208 may be located 5 km from the borehole 206. Such a location provides a transmitter-to-reference station separation of approximately 1 km to 6 km. However, the scope of the disclosure is not so limited. In other implementations, one or more reference stations 208 may be located less than 5 km or greater than 5 km from the borehole 206. As such, the transmitter-to-reference station separation may be less than 5 km or greater than 5 km.

The electric field source dipoles (transmitters 202) generate electric fields within the earth, and the receiver 204 detects resulting electric fields, magnetic fields, or both, as affected by the earth. Particularly, the receiver 204 can make measurements of the electric fields, magnetic fields, or both, generated by the transmitters 202 in both axial and equatorial configurations. As a result, the receiver 204 detects the resulting vertical electric fields and the resulting vertical magnetic fields generated by the transmitters 202. Analysis of the vertical electric and magnetic fields measured in the borehole provides an estimate of the resistivity of the surrounding reservoir.

The resulting electric and magnetic fields generated by the transmitters 202 are affected by inhomogeneities present in the near-surface formation 124. The galvanic distortion associated with these inhomogeneities lead to inaccurate readings of the reservoir 112 and, thus, result in inaccurate detection of the waterfront within the reservoir 112. The inhomogeneities for which correction is desired may be small with respect to the transmitter spacing and are, therefore, noise to the STB measurements. The galvanic distortion caused by the inhomogeneities produces a frequency-independent amplitude shift or gain in the amplitude of electric field measurements while leaving the phase of the resulting electric field largely unaltered. This frequency-independent amplitude shift or gain is referred to as a “static shift.” A first order effect of these inhomogeneities is a change in the electric field amplitude. In order to remove the distortion and provide an improved representation of the reservoir, the distortion caused by the inhomogeneities is removed with the use of recorded reference electric and magnetic field measurements, which in some instances, may be recorded during the STB acquisition. In other implementations, these magnetic and electric field measurements may be collected at a time other than when the STB survey measurements are performed. These reference electric and magnetic fields measurements are obtained by the reference stations 208. The reference stations 208 obtain the reference electric and magnetic measurements using magnetotelluric acquisition systems or similar recording devices.

FIG. 3 shows an example reference station, which may be similar to the reference station 208, in the form of a natural source magnetotelluric system 300. The example magnetotelluric system 300 includes a logger 302, two orthogonal grounded dipoles 304; three induction coil magnetometers 306; a power source, such as a battery 308; and a GPS antenna 310 used to identify a position of reference station 208 and for timing purposes. In some implementations, the logger 302 is a 24-bit logger. However, in other implementations, the logger 302 may be of any desired bit size. Each of the orthogonal grounded dipoles 304 includes opposing electrodes. The orthogonal grounded dipole 304 extending in an east and west orientation includes an east electrode 316 and a west electrode 318. The orthogonal grounded dipole 304 extending in a north and south orientation includes a north electrode 312 and a south electrode 314. The example reference station also includes a ground electrode 320. Other reference station configurations are contemplated. At each of the reference stations 208, five components of the electromagnetic field are measured. These five components are Eₓ, E_{y}, Hₓ, H_{y}, and H_{z}. The two orthogonal grounded dipoles 304 measure the electric field components Eₓ and E_{y}, while the induction coil magnetometers 306 measure the magnetic field components Hₓ, H_{y}, and H_{z}. In other implementations, other types of devices may be used to measure the vertical magnetic field naturally occurring in the formation, also referred to as the vertical magnetic field of the earth. For example, devices capable of measuring satellite-synchronized electric and magnetic field measurements may be used for this purpose. The vertical magnetic field, H_{z}, and the horizontal electric fields, Eₓ and E_{y}, are the particular components used to remove the near-surface galvanic distortion from the STB survey measurements, as discussed in more detail later.

The resistivity of the near-surface can often vary spatially at a scale much smaller than the scale of the geophysical investigation. These small-scale variations that produce distortions in the STB measurements may be related to weathering, karsting, or variations in soil and sand cover. When these small-scale features are present, the resulting galvanic distortions of these small-scale features are aliased and become noise to the larger scale geophysical investigation.

STB measurements of the resulting electric field obtained by the receiver 204 may be made parallel to the transmitters 202 in both axial and equatorial configurations. The resulting electric field corresponds to the electric field generated by the transmitters 202 and is affected by the formations and, particularly, the near-surface inhomogeneities. As a result of the galvanic distortion produced by the near-surface inhomogeneities, measurements of the resulting vertical electric field are shifted in amplitude, since some of the transmitter moment is lost to the perpendicular transmitter created by distortion. Therefore, first order distortion effects caused by the near-surface inhomogeneities are a frequency-independent amplitude shift that leaves the phase unaltered. These “static shifts” are removable with the use of the reference electric and magnetic field measurements, particularly, the vertical magnetic field measurements obtained by reference stations, such as the reference stations 300 shown in FIG. 3.

The reference measurements obtained by the reference stations 300 are made in axial and equatorial configurations with respect to the STB transmitters 202 (for example, transmitting dipoles) as shown, for example, in FIG. 2. The distortion contained in the STB data can be removed by recognizing that the vertical magnetic field of the earth becomes independent of the resistivity structure at low frequencies. The low frequencies include frequencies within a range of 0.1 to 10 Hz. The DC vertical magnetic field is given by:

$${H}_{z} = \frac{I dl cos Θ}{4 π {R}^{2}} . \qquad ( Equation 2 )$$

In Equation 2, I is the current; dl is the length of the dipole; R is the separation between the transmitter and the receiver; and Θ is the angle from the perpendicular of the transmitter.

FIG. 4 shows a plot of the vertical magnetic field (H_{z}) of the earth (having units in nanotesla (nT)) measured by a reference station (such as a reference station 300 shown in FIG. 3) having a 6 km offset and halfspaces varying from 10 to 1000 ohm-m, where an offset is a separation between a transmitter and reference station and where a halfspace is an area of the Earth's surface having a constant resistivity. Although the reference station is described as having a 6 km offset in the described example, other offsets are within the scope of the disclosure. In other implementations, the offset of one or more reference stations may have an offset of less than 6 km, while in still other implementations, one or more of the reference stations may have an offset of greater than 6 km. FIG. 4 shows vertical magnetic fields calculated at varying frequencies for varying constant resistivities. Particularly, in the illustrated example, the resistivities are 10 ohm-m, 32 ohm-m, 100 ohm-m, 320 ohm-m, and 1000 ohm-m. The DC magnetic field is independent of resistivity, as indicated by line 400. For each of these vertical magnetic fields shown in FIG. 4, the respective curves converge to the DC value at low frequencies. The frequency at which the value approaches the DC value is dependent on the resistivity (as shown in FIG. 4). As such, what is considered a low frequency may be vary depending on the resistivity. The frequency where this convergence occurs depends on the resistivity, as illustrated by FIG. 4. Therefore, at low frequencies, the vertical magnetic field of the earth may be approximated at a DC magnetic field. This approximation occurs at offsets of less than a skin depth, which is previously explained.

The galvanic distortion present in the acquired STB data is removed by determining the static shift through equating the vertical magnetic field of the earth measured by the reference stations to a DC value calculated for the transmitter, as explained earlier. FIG. 5 graphically illustrates this correction, the gain recovered from shifting the vertical magnetic field at a frequency of approximately 0.1 Hz will recover the shift observed in the electric field.

FIG. 12 shows an example method 1200 of removing galvanic distortions associated near-surface inhomogeneities using a static shift correction factor. At 1202, an STB survey is initiated. At 1204, a horizontal electric field and a vertical magnetic field are generated at a surface of the earth with a plurality of dipole transmitters. The dipole transmitters may be arranged in an array of radials extending outwardly from the borehole. At 1206, the generated vertical magnetic field and the generated vertical electric field are detected at a depth of the reservoir with an STB receiver located in the borehole. At 1208, a vertical magnetic field of the earth is detected using a plurality of magnetotelluric reference stations. A plurality of reference stations may be used. Each of the reference stations is aligned with one of the radials extending outwards from the borehole, and the reference stations are disposed outwards of the dipole transmitters contained in the radials. In some instances, the vertical magnetic field of the earth measurements may be made during the STB survey. In other instances, the vertical magnetic field of the earth measurements may be made at a different time. At 1210, using the relationship

$${H}_{z} = \frac{I dl cos Θ}{4 π {R}^{2}}$$

(that corresponds to Equation 2, shown earlier) the detected vertical magnetic field measured by a reference station is equated to a determined DC value for each of the dipole transmitters located in a radial located on the opposite side of the borehole but aligned with the radial containing the reference station. At 1212, a static shift correction factor for the STB survey measurements is determined by solving for the term I dl (dipole moment) from the equation. At 1214, the static shift correction factor is applied to the vertical magnetic field and vertical electric field measurements detected at the depth of the reservoir during the STB survey as well as to the detected vertical magnetic field of the earth to remove the galvanic distortion associated with near-surface inhomogeneities and provide resistivity representation of the reservoir.

Elimination of the galvanic distortion in this way has an advantage of eliminating the cost associated with other approaches that involve attempting to mitigate the near-surface galvanic distortions by dense sampling of the near-surface with shallow electromagnetic data collection or installing transmitter electrodes in shallow boreholes. In some implementations, the shallow boreholes may be 5 to 7 meters (m) in depth. In other implementations, the shallow boreholes may greater than 7 m in depth. The methods described in the present disclosure avoid that cost because creation of these additional wells is unnecessary.

Another approach for correcting for near-surface electric field or galvanic distortion caused by near-surface inhomogeneities is now described. It has been shown that, when an electric field is measured in close proximity to a small-scale resistivity anomaly and at low frequencies where induction currents in the anomaly have decayed away, the measured electric field is the electric field that would be measured in the absence of the anomaly multiplied by a frequency independent distortion tensor. Low frequencies are frequencies less than 10 Hz.

The measured electric field becomes:

Eₘₑₐₛ=D E_{undistorted} (Equation 3)

where Eₘₑₐₛ is the measured electric field, D is a 2×2 real distortion tensor, and E_{undistorted} is the electric field that would be measured in the absence of the galvanic distortion resulting from the near-surface inhomogeneities, which may be referred to as small-scale resistivity anomaly. The orthogonal components of the measured electrical field are a mixture of the undistorted components. This distortion can be mitigated. For example, when the data are in a coordinate system of the larger scale structure, such as the undistorted overburden, the distortion simplifies to a frequency independent gain for each of the electric field components, termed static shifts.

Removal of the near-surface galvanic distortion described earlier may be affected by man-made magnetic field noise generated, for example, by load changes in power lines or magnetic fields produced by cathodic protected devices. In order to avoid these influences, more statistically robust methods using a distortion tensor are also disclosed. According to another implementation, the near-surface galvanic distortion is removed by incorporating a distortion tensor created with the use of reference measurements, described later, into STB survey measurements. An inversion to correct for these distortions may be carried out prior to analysis of the STB data or as part of the analysis process to estimate reservoir properties.

FIGS. 6 and 7 show an example realistic earth 3D resistivity model 600 used to illustrate removal of the near-surface galvanic distortion caused by near-surface inhomogeneities. The model 600 includes an STB survey arrangement similar to that described earlier in the context of FIGS. 1 and 2. FIG. 6 is a plan view of the model 600, and FIG. 7 is a section view of the model 600. The example model 600 includes seven near-surface resistivity anomalies 602 aligned with a series of transmitters 601 arranged in a linear fashion. These near-surface resistivity anomalies 602 represent inhomogeneities. In the illustrated example of FIG. 6, the transmitters 601 are distributed over a distance of 10,000 meters. However, as explained previously, the distance over which the transmitters are distributed may vary. For example, this distance may vary depending upon the depth of the reservoir. The transmitters 601 may be a grounded dipole transmitter, similar to those described earlier. The plurality of transmitters 601 are disposed at the surface 608. The anomalies 602 are 10 meters (m) thick, have resistivities varying from 0.1 to 1000 ohm-meters, and are located in a 46.5 ohm-meters layer 620. The number of near-surface resistivity anomalies 602 is inconsequential to the methods of removing the corresponding galvanic distortion described in the present disclosure, and the number of anomalies 602 present in the example model 600 is provided merely as an example to illustrate the efficacy of the disclosed methods.

FIG. 7 is a section view of the example 3D resistivity model 600 of FIG. 6 taken along a pair of aligned radials 622 and showing formations 604 overlying a reservoir 606. Resistivities of the different formations 604 are shown graphically in key 621. In this example, the reservoir 606 is approximately 2000 m from the surface 608. A borehole 610 extends from the surface 608 to the reservoir 606. A downhole receiver 612 is located within the borehole 610 at a depth of the reservoir 606.

FIGS. 8 and 9 show the amplitude and phase, along a profile, of the simulated STB survey measurements obtained from the model 600 of FIGS. 6 and 7. FIG. 8 shows the amplitude of the vertical electric field data in volts per meter (V/m) measured by the receiver 612 as a result of the electric fields generated by the transmitters 601. Surface receivers 614 are disposed at the surface 608 at opposing ends of the series of transmitters 601 such that the series of transmitters 601 are located between the surface receivers 614. In some implementations, the surface receivers 614 may be similar to the surface receiver 300 described earlier. The surface receivers 614 measure the electric and magnetic fields generated by the transmitters 601 and as affected by the formations 604.

The curve 800 represents the unaltered measurements of the electric field along a profile. The X-axis in FIG. 8 is position along the profile in kilometers or 1E3 m. The points 802 indicate the electric field with the distortion associated with the near-surface resistivity anomalies 602. The goal is to recover unaltered electric field data in order to recover the reservoir resistivity. As shown in FIG. 8, the unaltered electric field curve 800 generally does not conform well to the points 802 that reflect the electric field with the galvanic distortion from the near-surface anomalies 602. This nonconformance is the result of the resistivity distortion caused by the near-surface anomalies 602.

FIG. 9 shows the phase of the vertical electric field data measured by the receiver 612 along a profile. The X-axis in FIG. 9 is position along the profile in kilometers or 1E3 m. Thus, as shown in FIGS. 8 and 9, phase is unaltered by the anomalies 602, while the amplitude is altered in the presence of the anomalies 602.

In order remove the near-surface galvanic distortion according to this implementation, distortion tensors describing the electric field distortion are used. The distortion tensors are generated using reference measurements made by the surface receivers 614. STB analysis software (such as EMGeo® produced by the Lawrence Berkeley National Laboratory at 1 Cyclotron Road, Berkeley, Calif.) may be used to combine the electric field measurements to remove the distortion. The distortion is removed through inversion of the reference measurements, which are the electric field measurements measured at the surface receivers 614 and downhole receiver 612. For example, the reference measurements may be obtained concurrently with the STB survey measurements. For each transmitter 601, the vertical electric field is measured in the reservoir by the downhole receiver 612 (that represents the STB survey data) while the horizontal electric field is measured by the surface receivers 614 (that represents the reference data). This inversion can be carried out prior to analysis of the STB data or as part of the process to estimate reservoir properties.

FIG. 10 shows another cross-section of the model 600 shown in FIGS. 6 and 7 and shows acquisition of electric field measurements resulting from output by two STB transmitters 601 by downhole receiver 612 and surface receivers 614. The model 600 is a starting resistivity model that is generated using well log data and surface geophysics and may be similar to the model 100 shown in FIG. 1. Resistivities of the different formations 604 are shown graphically in key 621. This resistivity estimates the resistivity of the overburden formations 604 based on the well log data. The vertical electric field is measured by the downhole receiver 612, and the horizontal electric field is measured by the surface receivers 614. The overburden formations 604 of the model 600 adjacent the reservoir 606 has a uniform resistivity set to a value derived from interpretation of well logs. Corrections for the near-surface galvanic distortion are determined for two of the plurality of radially orientated sources dipole transmitters 601, shown in FIG. 10 as Tₓ₁ and Tₓ₂, as an example. The corrections for these two transmitters Tₓ₁ and Tₓ₂ are made using two horizontal reference electric field measurements. These reference horizontal electric field measurements are made by the surface receivers 614, shown in FIG. 10 as R₁ and R₂ (also referred to as reference stations). Since the distortion causes the equivalent of the gain factor, the horizontal electric fields measured at the surface are shifted by the same factor as the vertical electric fields measured downhole. Thus, for each transmitter Tₓ₁ and Tₓ₂, one of the two radial oriented reference electric field measurement is made by R₁ while the other reference measurement is made by R₂. All electric field measurements and transmissions are assumed to have near-surface distortion, including those measurements made by surface receivers 614 (that is, R₁ and R₂).

In this example, the electric fields generated by the transmitters Tₓ₁ and Tₓ₂ and as affected by the formations are simultaneously recorded in the borehole 610 by the downhole receiver 612 as part of the STB survey and by the surface receivers 614, R₁ and R₂, for the near-surface galvanic distortion correction. In the illustrated example, the surface transmitters Tₓ₁ and Tₓ₂ are radially oriented dipole sources, and each of the reference stations, R₁ and R₂, record two horizontal components of the electric field, that is, E_{radial} and E_{azimuthal} and one component of the magnetic field, that is, the vertical component of the magnetic field, H_{vertical} for each transmitter Tₓ₁ and Tₓ₂. The correction for transmitters Tₓ₁ and Tₓ₂ is obtained with the use of the E_{radial} field.

The system of equations that results from the two axial or equatorial reference measurements from each transmitter Tₓ₁ and Tₓ₂ is as follows:

E₁=S_{Tx1}S_{R1}E_{1undistorted} (Equation 4)

E₂=S_{Tx1}S_{R2}E_{2undistorted} (Equation 5)

E₃=S_{Tx2}S_{R1}E_{3undistorted} (Equation 6)

E₄=S_{Tx2}S_{R2}E_{4undistorted} (Equation 7)

This set of equations gives the electric fields (E₁ and E₂) observed at R₁ and R₂ as a result of transmissions from Tₓ₁ and electric fields (E₃ and E₄) observed at R₁ and R₂ resulting from Tₓ₂. S_{Tx1}, S_{Tx1}, S_{R1} and S_{R2} are scaling or distortion factors that result from the near-surface galvanic distortion, and these scaling factors are determined using this system of equations. These scaling factors represent the “D” in the equation Eₘₑₐₛ=DE_{unistorted}, described earlier. The scalar distortion factors S_{Tx1} and S_{Tx2} are “gains” that are created or could be created by structures located near Tₓ₁ and Tₓ₂, respectively, and by potential structures at R₁ and R₂, respectively. E₁ and E₂ are radial electric fields measured at R₁ and R₂ produced by Tₓ₁ and Tₓ₂, and E₃ and E₄ are radial electric fields measured at R₁ and R₂ as a result of Tₓ₂. E₁, E₂, E₃, and E₄ are radial electric fields. The equations also show the electric fields E₁, E₂, E₃, and E₄ as a product that includes the electrical fields free of the near-surface galvanic distortion, that is, E_{1unistorted}, E_{2undistorted}, E_{3undistorted}, and E_{4undistorted}, respectively. E_{1undistorted}, E_{2undistorted}, E_{3ndistorted}, and E_{4ndistorted} are radial electric fields that are predicted by R₁ and R₂ using the resistivity model 600. An inversion process is used to solve for the four distortion factors, S_{Tx1}, S_{Tx1}, S_{R1} and S_{R2}. The inversion process also simultaneously adjusts the starting resistivity model 600 to fit the measured data, that is, the electric field data recorded by the surface receivers 614 and resulting from the transmitters 601.

In this example, the system of equations contains four equations with four unknowns, that is, S_{Tx1}, S_{Tx1}, S_{R1} and S_{R2}. In some implementations, these unknowns are determined using least squares minimization. For example, the STB analysis software discussed earlier may be used to perform the least squares minimization process to determine the unknown distortion parameters. Further, as more transmitters 601 are added, the number of equations grows faster than the number of unknowns. Although the number of surface receivers 614 may also grow as the number of transmitters 601 grows, the number of surface receivers 614 grows at a slower pace. Consequently, the scaling factors are determinable. For example, in some implementations, the scaling factors are determinable through least squares minimization added to the 3D inversion of the STB survey measurement data. The 3D inversion calculates the electric fields measured at the reference stations and iteratively alters the starting resistivity model so that the electric fields predicted by the resistivity model fit the electrical fields measured by the surface receivers. The distortion factors are found simultaneously and the introduction of the distortion factors prevents introduction of unnecessary resistivity structure. With the distortion factors for each transmitter determined, the distortion factors are applied to the STB survey data to correct the data for galvanic distortions caused by near-surface inhomogeneities.

Each of the STB survey measurements is multiplied by the distortion tensor for the transmitter that generated the vertical electric field measured by the borehole receiver. Thus, a tensor exists for each transmitter, and the tensor is multiplied with the vertical electric field resulting from a transmitter and as measured by the borehole receiver. In the proposed acquisition geometry where all measurements are made in an axial or equatorial configuration parallel to the transmitters (such as the acquisition geometry illustrated in FIGS. 2 and 6), these tensors simplify to a single scalar. Since each dipole transmitter 601 has at least two axial or equatorial reference measurements (that, again, are obtained by R₁ and R₂, respectively), the resulting system of the equations has an equal number of equations and unknowns and can be solved through inclusion in the inversion analysis of the STB data.

FIG. 11 shows the amplitude of the simulated STB survey electric field measurements presented in FIG. 8 but corrected with the determined distortion tensor via the 3D inversion. The distortion factors permit the inversion of the STB data without the introduction of bias due to small shallow resistivity variations. As explained earlier, the points 802 indicate the electric field with the distortion associated with the near-surface resistivity anomalies 602. The solid curve 1000 is the calculated model response with the electric field corrections described earlier. Particularly, the solid curve 1000 is the vertical magnetic field measurements with the near-surface galvanic distortions added. As can be seen, the solid curve 1000 follows the points 802 as a result of the correction. The dashed line 1010 shows the curve 800 originally presented in FIG. 8 and is a response of the model 600 without the near surface distortion. Therefore, as can be seen, the distortion tensor and STB inversion produces a reflection of the resistivity within the reservoir and thus, provides a representation of the reservoir and of how a waterfront moves within the reservoir over time that is improved in comparison to current approaches.

FIG. 13 is an example method 1300 of removing galvanic distortions associated near-surface inhomogeneities using a distortion tensor and inversion of STB reference measurements. At 1302, an STB survey is initiated. At 1304, a first electric field and a first magnetic field are generated at a first location on the surface of the earth. The first electric field may include a radial component, E_{radial1}, and an azimuthal component, E_{azimuthal1}, and the first magnetic field may include a vertical component, H_{vertical1}. At 1306, a second electric field and a second magnetic field are generated at a second location on a surface of the earth. The second electric field may include a radial component, E_{radial2}, and an azimuthal component, E_{azimuthal2}, and the second magnetic field may include a vertical component, H_{vertical2}. At 1308, the first electric field, the second electric field, the first magnetic field, and the second magnetic field are measured at a depth of a reservoir. At 1310, the first electric field and the second electric field are measured at two locations at the earth's surface. The two locations at the earth's surface may be different that the first and second locations on the earth's surface. For example, as shown in FIG. 10, the two locations where the first electric field and the second electric field are measured at a surface may be the positions of surface receivers 614. One of the locations may be located outwards of an array of a plurality dipole transmitters and aligned with the array. The second location may be disposed outwards of a second array of dipole transmitters and aligned with the second array. The first and second arrays may be aligned. At 1312, a distortion tensor is determined from a system of equations, similar to the system of equations described earlier, using the electric field measurements measured at the two locations at the earth's surface. At 1314, the distortion tensor is applied as an inversion to the E_{radial1} and E_{radial2} measured at the depth of the reservoir to remove the galvanic distortion associated with near-surface inhomogeneities and to provide a resistivity representation of the reservoir.

FIG. 14 is a block diagram of an example computer system 1400 used to provide computational functionalities associated with described algorithms, methods, functions, processes, flows, and procedures described in the present disclosure, according to some implementations of the present disclosure. The illustrated computer 1402 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1402 can include input devices such as keypads, keyboards, and touch screens that can accept user information. Also, the computer 1402 can include output devices that can convey information associated with the operation of the computer 1402. The information can include digital data, visual data, audio information, or a combination of information. The information can be presented in a graphical user interface (UI) (or GUI).

The computer 1402 can serve in a role as a client, a network component, a server, a database, a persistency, or components of a computer system for performing the subject matter described in the present disclosure. The illustrated computer 1402 is communicably coupled with a network 1430. In some implementations, one or more components of the computer 1402 can be configured to operate within different environments, including cloud-computing-based environments, local environments, global environments, and combinations of environments.

At a high level, the computer 1402 is an electronic computing device operable to receive, transmit, process, store, and manage data and information associated with the described subject matter. According to some implementations, the computer 1402 can also include, or be communicably coupled with, an application server, an email server, a web server, a caching server, a streaming data server, or a combination of servers.

The computer 1402 can receive requests over network 1430 from a client application (for example, executing on another computer 1402). The computer 1402 can respond to the received requests by processing the received requests using software applications. Requests can also be sent to the computer 1402 from internal users (for example, from a command console), external (or third) parties, automated applications, entities, individuals, systems, and computers.

Each of the components of the computer 1402 can communicate using a system bus 1403. In some implementations, any or all of the components of the computer 1402, including hardware or software components, can interface with each other or the interface 1404 (or a combination of both), over the system bus 1403. Interfaces can use an application programming interface (API) 1412, a service layer 1413, or a combination of the API 1412 and service layer 1413. The API 1412 can include specifications for routines, data structures, and object classes. The API 1412 can be either computer-language independent or dependent. The API 1412 can refer to a complete interface, a single function, or a set of APIs.

The service layer 1413 can provide software services to the computer 1402 and other components (whether illustrated or not) that are communicably coupled to the computer 1402. The functionality of the computer 1402 can be accessible for all service consumers using this service layer. Software services, such as those provided by the service layer 1413, can provide reusable, defined functionalities through a defined interface. For example, the interface can be software written in JAVA, C++, or a language providing data in extensible markup language (XML) format. While illustrated as an integrated component of the computer 1402, in alternative implementations, the API 1412 or the service layer 1413 can be stand-alone components in relation to other components of the computer 1402 and other components communicably coupled to the computer 1402. Moreover, any or all parts of the API 1412 or the service layer 1413 can be implemented as child or sub-modules of another software module, enterprise application, or hardware module without departing from the scope of the present disclosure.

The computer 1402 includes an interface 1404. Although illustrated as a single interface 1404 in FIG. 14, two or more interfaces 1404 can be used according to particular needs, desires, or particular implementations of the computer 1402 and the described functionality. The interface 1404 can be used by the computer 1402 for communicating with other systems that are connected to the network 1430 (whether illustrated or not) in a distributed environment. Generally, the interface 1404 can include, or be implemented using, logic encoded in software or hardware (or a combination of software and hardware) operable to communicate with the network 1430. More specifically, the interface 1404 can include software supporting one or more communication protocols associated with communications. As such, the network 1430 or the interface's hardware can be operable to communicate physical signals within and outside of the illustrated computer 1402.

The computer 1402 includes a processor 1405. Although illustrated as a single processor 1405 in FIG. 14, two or more processors 1405 can be used according to particular needs, desires, or particular implementations of the computer 1402 and the described functionality. Generally, the processor 1405 can execute instructions and can manipulate data to perform the operations of the computer 1402, including operations using algorithms, methods, functions, processes, flows, and procedures as described in the present disclosure.

The computer 1402 also includes a database 1406 that can hold data for the computer 1402 and other components connected to the network 1430 (whether illustrated or not). For example, database 1406 can be an in-memory, conventional, or a database storing data consistent with the present disclosure. In some implementations, database 1406 can be a combination of two or more different database types (for example, hybrid in-memory and conventional databases) according to particular needs, desires, or particular implementations of the computer 1402 and the described functionality. Although illustrated as a single database 1406 in FIG. 14, two or more databases (of the same, different, or combination of types) can be used according to particular needs, desires, or particular implementations of the computer 1402 and the described functionality. While database 1406 is illustrated as an internal component of the computer 1402, in alternative implementations, database 1406 can be external to the computer 1402.

The computer 1402 also includes a memory 1407 that can hold data for the computer 1402 or a combination of components connected to the network 1430 (whether illustrated or not). Memory 1407 can store any data consistent with the present disclosure. In some implementations, memory 1407 can be a combination of two or more different types of memory (for example, a combination of semiconductor and magnetic storage) according to particular needs, desires, or particular implementations of the computer 1402 and the described functionality. Although illustrated as a single memory 1407 in FIG. 14, two or more memories 1407 (of the same, different, or combination of types) can be used according to particular needs, desires, or particular implementations of the computer 1402 and the described functionality. While memory 1407 is illustrated as an internal component of the computer 1402, in alternative implementations, memory 1407 can be external to the computer 1402.

The application 1408 can be an algorithmic software engine providing functionality according to particular needs, desires, or particular implementations of the computer 1402 and the described functionality. For example, application 1408 can serve as one or more components, modules, or applications. Further, although illustrated as a single application 1408, the application 1408 can be implemented as multiple applications 1408 on the computer 1402. In addition, although illustrated as internal to the computer 1402, in alternative implementations, the application 1408 can be external to the computer 1402.

The computer 1402 can also include a power supply 1414. The power supply 1414 can include a rechargeable or non-rechargeable battery that can be configured to be either user- or non-user-replaceable. In some implementations, the power supply 1414 can include power-conversion and management circuits, including recharging, standby, and power management functionalities. In some implementations, the power-supply 1414 can include a power plug to allow the computer 1402 to be plugged into a wall socket or a power source to, for example, power the computer 1402 or recharge a rechargeable battery.

There can be any number of computers 1402 associated with, or external to, a computer system containing computer 1402, with each computer 1402 communicating over network 1430. Further, the terms “client,” “user,” and other appropriate terminology can be used interchangeably, as appropriate, without departing from the scope of the present disclosure. Moreover, the present disclosure contemplates that many users can use one computer 1402 and one user can use multiple computers 1402.

Described implementations of the subject matter can include one or more features, alone or in combination.

For example, in a first implementation, a computer-implemented method of removing galvanic distortion associated with near-surface inhomogeneities from surface-to-borehole (STB) survey measurements to provide resistivity information of an oil-bearing reservoir, the method including: generating a horizontal electric field and a vertical magnetic field at a surface of the earth with a dipole transmitter; measuring the vertical electric field and the vertical magnetic field at a depth of the reservoir; measuring a vertical magnetic field; determining a DC value for the dipole transmitter; equating the magnetic field measurements to the determined DC value according to the equation

$${H}_{z} = \frac{I dl cos Θ}{4 π {R}^{2}} ;$$

solving for I dl from the equation to determine a static shift correction factor; and applying the static shift correction factor to the vertical magnetic field measurements, the vertical electric field measurements, and the vertical magnetic field measurements to remove the galvanic distortion associated with near-surface inhomogeneities and provide a resistivity representation of the reservoir.

The foregoing and other described implementations can each, optionally, include one or more of the following features:

A first feature, combinable with any of the following features, wherein generating a vertical magnetic field at a surface of the earth with a dipole transmitter comprises generating a magnetic field with each of a plurality of dipole transmitters.

A second feature, combinable with any of the previous or following features, wherein the plurality of dipole transmitters is arranged in a plurality of radials extending outwards from a borehole, each radial being aligned with another radial on an opposing side of the borehole.

A third feature, combinable with any of the previous or following features, wherein measuring a vertical magnetic field comprises measuring the low frequency magnetic field generated by the STB transmitting dipoles. Specifically, the frequency is lowered to determine a value that approximates the DC vertical magnetic field.

A fourth feature, combinable with any of the previous or following features, wherein determining a DC value for the dipole transmitter comprises determining a DC value for each dipole transmitter of the plurality of dipole transmitters.

A fifth feature, combinable with any of the previous or following features, wherein measuring the vertical magnetic field at a depth of the reservoir comprises measuring the vertical magnetic field with an STB receiver disposed in the borehole at a depth of the reservoir.

In a second implementation, a non-transitory, computer-readable medium storing one or more instructions executable by a computer system to perform operations including: generating a first electric field and a first magnetic field at a first location on a surface of the earth, the first electric field comprising a radial component, E_{radial1}, and an azimuthal component, E_{azimuthal1}, and the first magnetic field comprising a vertical component, H_{vertical1}; generating a second electric field and a second magnetic field at a second location on a surface of the earth, the second electric field comprising a radial component, E_{radial2}, and an azimuthal component, E_{azimuthal2}, and the second magnetic field comprising a vertical component, Hᵥₑᵣₜᵢₐₗ₂; measuring E_{radial1}, E_{radial2}, E_{azimuthal1}, E_{azimuthal2}, H_{vertical1}, and H_{vertical2} at a depth of the reservoir; measuring E_{radial1}, E_{radial2}, E_{azimuthal1}, E_{azimuthal2}, H_{vertical1}, and H_{vertical2} at first and second measuring locations at a surface of the earth; determining a distortion tensor from scaling factors S_{Tx1}, S_{Tx2}, SRI, and S_{R2} according to the following set of equations:

E₁=S_{Tx1}S_{R1}E_{1undistorted},

E₂=S_{Tx1}S_{R2}E_{2undistorted},

E₃=S_{Tx2}S_{R1}E_{3undistorted},

E₄=S_{Tx2}S_{R2}E_{4undistorted},

where E₁ corresponds to E_{radial1} measured at the first measuring location, where E₂ corresponds to E_{radial1} measured at the second measuring location, where E₃ corresponds to the E_{radial2} measured at the first measuring location, where E₄ corresponds to E_{radial2} measured at the second measuring location, where E_{1undistorted} corresponds to a radial electric field at the first location without near surface inhomogeneities, where E_{2undistorted} corresponds to a radial electric field at the second location without near surface inhomogeneities, where E_{3undistorted} corresponds to a radial electric field at the first location without near surface inhomogeneities, and where E_{4undistorted} corresponds to a radial electric field at the second location without near surface inhomogeneities, E_{1undistorted}, E_{2undistorted}, E_{3undistorted}, and E_{4undistorted} being predicted values obtained from a starting resistivity model, determining the distortion tensor by applying an inversion to the set of equations; and applying the distortion tensor during an inversion of the E_{radial1} and E_{radial2} measured at the first and second measurement locations to remove the galvanic distortion associated with near-surface inhomogeneities and provide a resistivity representation of the reservoir.

The foregoing and other described implementations can each, optionally, include one or more of the following features:

A first feature, combinable with any of the following features, wherein generating a first electric field and a first magnetic field at a first location on a surface of the earth comprises generating the first electric field and the first magnetic field with a dipole transmitter, and wherein generating a second electric field and a second magnetic field at a second location on a surface of the earth comprises generating the second electric field and the second magnetic field with a second dipole transmitter.

A second feature, combinable with any of the previous or following features, wherein the first location is disposed on a first side of a borehole extending from the surface to the reservoir and wherein the second location is on a second side of the borehole, opposite the first side.

A third feature, combinable with any of the previous or following features, wherein the first dipole transmitter is disposed in a first radial of an array of dipole transmitters, wherein the second dipole transmitter is disposed in a second radial of the array of dipole transmitters, and wherein the first radial is aligned with the second radial.

A fourth feature, combinable with any of the previous or following features, wherein the first dipole transmitter and the second dipole transmitter form an array of dipole transmitters, the array of dipole transmitters arranged in a plurality of radials extending outwardly from the borehole.

A fifth feature, combinable with any of the previous or following features, wherein radials on opposing sides of the borehole are aligned.

A sixth feature, combinable with any of the previous or following features, wherein the measurements obtained at the first measuring location and the second measuring location are obtained by a first reference station located at the first measuring location and a second reference station located at the second measuring location, wherein the first reference station and the second reference station form part of a plurality of measuring stations, and wherein each of the plurality of measuring stations is aligned with one of the radials of the plurality of radials and is disposed radially outwards of the dipole transmitters disposed in the radial in which the measuring station is located.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/nonvolatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of the disclosure have been described. Nevertheless, it will be understood that various modifications may be made without departing from the spirit and scope of the disclosure. For example, an STB survey design may contain additional or fewer radials than that shown in the example of FIG. 2. Accordingly, other embodiments are within the scope of the following claims.

What is claimed is:

1. A surface-to-borehole (STB) arrangement for collecting electric field and magnetic field data representative of a resistivity of a reservoir and overburden formations, the resistivity representing a depletion level of oil from the reservoir, the arrangement comprising:
a plurality of dipole transmitters arranged in a plurality of radials extending outwards from a borehole, each radial being aligned with another radial on an opposing side of the borehole;
an STB receiver disposed in the wellbore at a level of the reservoir, the STB receiver operable to measure a vertical electric field and a vertical magnetic field generated by one or more of the dipole transmitters, as affected by the reservoir and overburden formations; and
a plurality of reference stations, one of the plurality of reference stations disposed along each radial outwards from the plurality of dipole transmitters, the reference stations comprising a recording system operable to measure a vertical component of a present magnetic field and horizontal electric field components.

2. The arrangement of claim 1, wherein the adjacent radials are angularly offset by 45°.

3. The arrangement of claim 1, wherein each radial includes nine dipole transmitters.

4. The arrangement of claim 3, wherein the dipole transmitters are equally spaced along the radials.

5. The arrangement of claim 1, wherein each of the reference stations is disposed 5 km from the borehole.

6. The arrangement of claim 5, wherein each reference station is adapted to measure the vertical magnetic field generated by at least one of the dipole transmitters disposed on a radial aligned with and on an opposite side of the borehole from the radial on which the reference station is disposed.

7. The arrangement of claim 6, wherein a distance between one of the plurality of reference stations and one of the plurality of the dipole transmitters whose electric field is to be measured by the reference station is between 6 km and 10 km.

8. A method of removing galvanic distortion associated with near-surface inhomogeneities from surface-to-borehole (STB) survey measurements to provide resistivity information of an oil-bearing reservoir, the method comprising:
generating a horizontal electric field and a vertical magnetic field at a surface of the earth with a dipole transmitter;
measuring the vertical electric field and the vertical magnetic field at a depth of the reservoir;
measuring a vertical magnetic field at a reference station;
determining a direct current (DC) value for the dipole transmitter through low frequency transmission;
equating the vertical magnetic field recorded at the reference station to the determined DC value according to the equation
$${H}_{z} = \frac{I dl cos Θ}{4 π {R}^{2}} ;$$
solving for I dl from the equation to determine a static shift correction factor; and
applying the static shift correction factor to the vertical magnetic field measurements measured at the depth of the reservoir, the vertical electric field measurements measured at the depth of the reservoir, and the vertical magnetic field of the earth measurements to remove the galvanic distortion associated with near-surface inhomogeneities and provide a resistivity representation of the reservoir.

9. The method of claim 8, wherein generating a vertical magnetic field at a surface of the earth with a dipole transmitter comprises generating a magnetic field with each of a plurality of dipole transmitters.

10. The method of claim 9, wherein the plurality of dipole transmitters is arranged in a plurality of radials extending outwards from a borehole, each radial being aligned with another radial on an opposing side of the borehole.

11. The method of claim 10, wherein measuring a vertical magnetic field comprises measuring the low frequency magnetic field generated by the STB transmitting dipoles.

12. The method of claim 9, wherein determining a DC value for the dipole transmitter comprises determining a DC value for each dipole transmitter of the plurality of dipole transmitters.

13. The method of claim 8, wherein measuring the vertical magnetic field at a depth of the reservoir comprises measuring the vertical magnetic field with an STB receiver disposed in the borehole at a depth of the reservoir.

14. A method of removing galvanic distortion associated with near-surface inhomogeneities from surface-to-borehole (STB) survey measurements to provide resistivity information of an oil-bearing reservoir, the method comprising:
generating a first electric field and a first magnetic field at a first location on a surface of the earth, the first electric field comprising a radial component, E_{radial1}, and an azimuthal component, E_{azimuthal1}, and the first magnetic field comprising a vertical component, H_{vertical1};
generating a second electric field and a second magnetic field at a second location on a surface of the earth, the second electric field comprising a radial component, E_{radial2}, and an azimuthal component, E_{azimuthal2}, and the second magnetic field comprising a vertical component, H_{vertical2};
measuring E_{vertical1}, E_{vertical2}, H_{vertical1}, and H_{vertical2} at a depth of the reservoir;
measuring E_{radial}, E_{radial2}, E_{azimuthal1}, E_{azimuthal2}, H_{vertical1}, and H_{vertical2} at first and second measuring locations at a surface of the earth;
determining a distortion tensor from scaling factors S_{Tx1}, S_{Tx2}, S_{R1}, and S_{R2} according to the following set of equations:
E₁=S_{Tx1}S_{R1}E_{1undistorted},
E₂=S_{Tx1}S_{R2}E_{2undistorted},
E₃=S_{Tx2}S_{R1}E_{3undistorted},
E₄=S_{Tx2}S_{R2}E_{4undistorted},
where E₁ corresponds to E_{radial1} measured at the first measuring location, where E₂ corresponds to E_{radial1} measured at the second measuring location, where E₃ corresponds to the E_{radial2} measured at the first measuring location, where E₄ corresponds to E_{radial2} measured at the second measuring location, where E_{1undistorted} corresponds to a radial electric field at the first location without near surface inhomogeneities, where E_{2undistorted} corresponds to a radial electric field at the second location without near surface inhomogeneities, where E_{3undistorted} corresponds to a radial electric field at the first location without near surface inhomogeneities, and where E_{4undistorted} corresponds to a radial electric field at the second location without near surface inhomogeneities, E_{1undistorted}, E_{2undistorted}, E_{3undistorted}, and E_{4undistorted} being predicted values obtained from a starting resistivity model, determining the distortion tensor by applying an inversion to the set of equations; and
applying the distortion tensor during an inversion of the E_{radial1} and E_{radial2} measured at the first and second measurement locations to remove the galvanic distortion associated with near-surface inhomogeneities and provide a resistivity representation of the reservoir.

15. The method of claim 14, wherein generating a first electric field and a first magnetic field at a first location on a surface of the earth comprises generating the first electric field and the first magnetic field with a dipole transmitter, and
wherein generating a second electric field and a second magnetic field at a second location on a surface of the earth comprises generating the second electric field and the second magnetic field with a second dipole transmitter.

16. The method of claim 15, wherein the first location is disposed on a first side of a borehole extending from the surface to the reservoir and wherein the second location is on a second side of the borehole, opposite the first side.

17. The method of claim 16, wherein the first dipole transmitter is disposed in a first radial of an array of dipole transmitters, wherein the second dipole transmitter is disposed in a second radial of the array of dipole transmitters, and wherein the first radial is aligned with the second radial.

18. The method of claim 17, wherein the first dipole transmitter and the second dipole transmitter form an array of dipole transmitters, the array of dipole transmitters arranged in a plurality of radials extending outwardly from the borehole.

19. The method of claim 18, wherein the measurements obtained at the first measuring location and the second measuring location are obtained by a first reference station located at the first measuring location and a second reference station located at the second measuring location,
wherein the first reference station and the second reference station form part of a plurality of measuring stations, and
wherein each of the plurality of measuring stations is aligned with one of the radials of the plurality of radials and is disposed radially outwards of the dipole transmitters disposed in the radial in which the measuring station is located.

20. The method of claim 17, wherein radials on opposing sides of the borehole are aligned.
